(19) United States
(12) Patent Application Publication
(10) Pub. No.: US 2010/0159854 A1
(43) Pub. Date: Jun. 24, 2010

(54) METHOD AND APPARATUS FOR ADAPTIVELY CONTROLLING RECEIVED POWER OF MULTI-ANTENNA RADIO CHANNEL MEASUREMENT EQUIPMENT

(75) Inventors: Myung Don KIM, Daejeon (KR); Jae Joon PARK, Daejeon (KR); Heon Kook KWON, Daejeon (KR); Won Sop KIM, Jeonju-si (KR); Jun Hwan LEE, Seoul (KR); Young-Hoon KIM, Daejeon (KR); Hyun Kyu CHUNG, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: Electronics and Telecommunications Research Institute, Daejeon (KR)

(21) Appl. No.: 12/556,207

(22) Filed: Sep. 9, 2009

(30) Foreign Application Priority Data
Dec. 19, 2008 (KR) 10-2008-0129866

(51) Int. Cl. H04B 7/02

(52) U.S. Cl. 455/101

(57) ABSTRACT

Provided is an apparatus for adaptively controlling a received power of a multi-antenna radio channel measurement equipment, the apparatus including: a plurality of antennas to receive a measurement signal; a switch unit comprising a plurality of switches to input the measurement signal; a switch control unit to control the plurality of switches of the switch unit to sequentially input the measurement signal; a reception (Rx) attenuator to adjust a Received Signal Strength Indication (RSSI) of the measurement signal; an Rx AGC control unit to control the Rx attenuator to adaptively adjust the RSSI of the measurement signal; a timing control unit to generate a reference timing signal for the switch control unit and the automatic RSSI control unit; and a digital baseband control unit to collect and store information associated with the measurement signal.

### CROSS-REFERENCE TO RELATED APPLICATION

This application claims the benefit of Korean Patent Application No. 10-2008-0129866, filed on Dec. 19, 2008, in the Korean Intellectual Property Office, the disclosure of which is incorporated herein by reference.

### BACKGROUND

1. Field of the Invention

Embodiments of the present invention relate to a method of adaptively controlling a received power of a Multiple Input Multiple Output (MIMO) multi-antenna radio channel measurement equipment using a Time Division Multiplexing (TDM) scheme that may measure a radio channel to collect channel data with an optimal received power, and thereby may obtain accurate MIMO radio channel parameters such as a multi-path characteristic for each MIMO multi-antenna and the like.

2. Description of the Related Art

Generally, a multi-antenna radio channel measurement system called a radio channel sounder may include a transmit system and a receive system. In order to measure a radio channel in an urban area or in a busy traffic region, the multi-antenna radio channel measurement system may install the transmit system and multiple transmit antennas in a base station building or a transmission tower, and may install the receive system and multiple receive antennas in a vehicle to thereby measure the radio channel while traveling a particular route using the vehicle.

A method of measuring a radio channel using multiple antennas is used to measure and research a channel change in various types of environments in an aspect of a radio channel from a base station, that is, in an aspect of a downlink, according to a travel route of the vehicle.

A Multiple Input Multiple Output (MIMO) multi-antenna radio channel measurement system may be classified into a radio channel measurement system using a Code Division Multiplexing (CDM) scheme and a radio channel measurement system using a Time Division Multiplexing (TDM) scheme.

Generally, the radio channel measurement system of the CDM scheme may include a plurality of baseband modules and a plurality of radio frequency (RF) module, and may transmit a different transmission code for each channel. Accordingly, the radio channel measurement system of the CDM scheme may be used to measure a radio channel with respect to an Orthogonal Frequency Division Multiplexing (OFDM) transmission, and to analyze a radio channel in a frequency domain.

Also, the radio channel measurement system of the TDM scheme may generally use the same transmission probing code, and may include a plurality of transmit antennas and receive antennas, and a single RF module to temporally switch an antenna. Accordingly, in comparison to the radio channel measurement system of the CDM scheme, the radio channel measurement system of the TDM scheme is relatively simple and may be used to measure and analyze a radio channel in a time domain.

The conventional radio channel measurement system may use an automatic gain control (AGC) scheme in order to control the level of Rx power that is received by a receiver of a radio apparatus via an antenna. Also, the radio channel measurement system may measure a Received Signal Strength Indication (RSSI) value of an intermediate frequency (IF) signal and compare the measured RSSI value of the IF signal with a threshold value.

However, in the conventional art, in the radio channel measurement system of the TDM scheme that applies a plurality of antennas and a single RF module, a newly set AGC value may be applied as same for all the antennas. Therefore, received power level of signals for some antennas may be saturated. As a result, when measuring and analyzing a radio channel, multiple path waves may be abnormally measured.

Accordingly, there is a need for an apparatus and method that may calculate an appropriate Rx power control value for each antenna, and apply the calculated Rx power control value to a corresponding antenna.

### SUMMARY

An aspect of the present invention provides an apparatus for adaptively controlling a received power of a multi-antenna radio channel measurement equipment that may classify, for each of transmit-receive antennas, a Received Signal Strength Indication (RSSI) of a radio wave, received by a receiver of a Multiple Input Multiple Output (MIMO) multi-antenna radio channel measurement system using a Time Division Multiplexing (TDM) scheme, to estimate a corresponding RSSI value, and adaptively control an attenuation value of the receiver according to a combination of the transmit-receive antennas based on the estimated RSSI value, and thereby may collect optimal reception data and may control the RSSI value, received for each of the receive antennas, to overcome a strength difference caused by a reception path, and to be uniformly distributed.

Another aspect of the present invention also provides an apparatus for adaptively controlling a received power of a multi-antenna radio channel measurement equipment that may set an Rx attenuator setting time and thereby may effectively use an invalid time of received data and may also immediately apply a new Rx AGC value for each of M×N transmit-receive antennas.

According to an aspect of the present invention, there is provided an apparatus for adaptively controlling a received power of a multi-antenna radio channel measurement equipment, the apparatus including: a plurality of antennas to receive a measurement signal; a switch unit comprising a plurality of switches to input the measurement signal; a switch control unit to control the plurality of switches of the switch unit to sequentially input the measurement signal; a reception (Rx) attenuator to adjust the power level of the measurement signal; an Rx AGC control unit to control the Rx attenuator to adaptively adjust the power level of the measurement signal; a timing control unit to generate a reference timing signal for the switch control unit and the Rx AGC control unit; and a digital baseband control unit to collect and store information associated with the measurement signal.

The Rx AGC control unit may classify an RSSI of a radio wave, received for each of M×N transmit-receive antennas, to estimate a corresponding RSSI value based on a transmit antenna switching timing and a receive antenna switching timing that are provided from the timing control unit, and may adaptively control the Rx attenuator based on the estimated RSSI value.

Also, the Rx AGC control unit may set an Rx attenuator setting time in order to immediately apply a newly set Rx AGC value within a switching delay time of M×N transmit-receive antennas. Here, the Rx AGC value may be newly set for each of M×N transmit-receive antennas.

Also, the Rx AGC control unit may use, as information to calculate a RSSI value, only valid data that is used as radio channel analysis information by the multi-antenna radio channel measurement equipment of a TDM scheme.

Also, the Rx AGC control unit may classify the RSSI value using the valid data for each of M×N transmit-receive antennas, and adaptively control the Rx attenuator based on the classified RSSI value.

When the classified RS SI value is greater than a predetermined threshold value, the Rx AGC control unit may calculate, as a power difference value, a value that is obtained by subtracting the threshold value from the classified RSSI value. Also, the Rx AGC control unit may calculate, as an automatic gain control (AGC) value for controlling the Rx attenuator, a value that is obtained by subtracting the power difference value from the formerly set AGC value.

Conversely, when the classified RSSI value is less than or equal to a predetermined threshold value, the Rx AGC control unit may calculate, as a power difference value, a value that is obtained by subtracting the classified RSSI value from the threshold value. Also, the Rx AGC control unit may calculate, as a new AGC value for controlling the Rx attenuator, a value that is obtained by adding up the power difference value and the formerly set AGC value.

According to another aspect of the present invention, there is provided a method of adaptively controlling a received power, the method including: setting a value of an Rx attenuator at a maximum value; automatically setting an AGC value; sequentially switching M transmit antennas and N receive antennas according to a predetermined timing; measuring a radio channel for each of M×N transmit-receive antennas to generate measurement information; calculating an RSSI value for each of the M×N transmit-receive antennas, based on the measurement information; calculating a new AGC value based on the RSSI value and a predetermined threshold value; and storing the AGC value.

### Effect

According to embodiments of the present invention, it is possible to classify, for each of transmit-receive antennas, a Received Signal Strength Indication (RSSI) of a radio wave, received by a receiver of a Multiple Input Multiple Output (MIMO) multi-antenna radio channel measurement system using a Time Division Multiplexing (TDM) scheme, to estimate a corresponding RSSI value, and to adaptively control an attenuation value of the receiver according to a combination of the transmit-receive antennas based on the estimated RSSI value. Through this, it is possible to collect optimal reception data, and to control the RSSI value, received for each of the receive antennas, to overcome a strength difference caused by a reception path, and to be uniformly distributed.

Also, according to embodiments of the present invention, it is possible to set an Rx attenuator setting time and to thereby effectively use an invalid time of received data and to immediately apply a new Rx AGC value for each of M×N transmit-receive antennas.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of an apparatus for adaptively controlling a received power of a multi-antenna radio channel measurement equipment according to an embodiment of the present invention;

FIG. 2 is a diagram illustrating an example of a reference timing generated by a timing control unit according to an embodiment of the present invention;

FIG. 3 is a flowchart illustrating a method of adaptively controlling a received power of a multi-antenna radio channel measurement equipment according to an embodiment of the present invention; and

FIG. 4 is a flowchart illustrating an operation of calculating an automatic gain control (AGC) value based on a RSSI value and a predetermined threshold value shown in FIG. 3.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

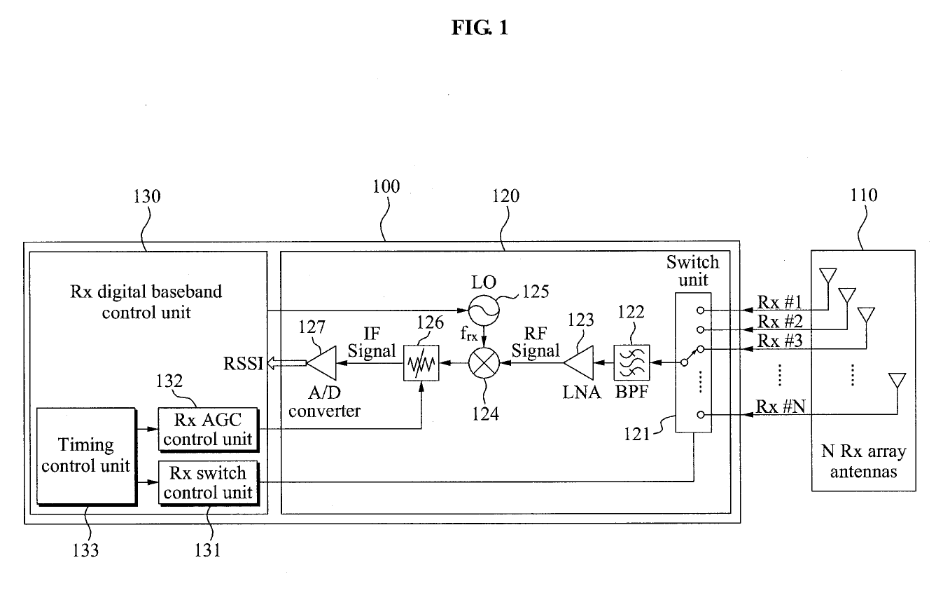

FIG. 1 is a diagram illustrating a configuration of an apparatus 100 for adaptively controlling a received power of a multi-antenna radio channel measurement equipment according to an embodiment of the present invention.

Referring to FIG. 1, when the adaptive control apparatus 100 of the multi-antenna radio channel measurement equipment receives a measurement signal via an antenna unit 110, a signal transfer unit 120 may sequentially adjust the measurement signal and transfer the adjusted measurement signal to a reception (Rx) digital baseband control unit 130.

Here, the antenna unit 110 may include N Rx array antennas.

The signal transfer unit 120 may include a switch unit 121 including a plurality of switches to input the measurement signal, a band pass filter (BPF) to filter the measurement signal and to limit a band, a low noise amplifier (LNA) 123 to amplify the filtered measurement signal so that no noise may be included, a multiplexer 124 to down-convert the measurement signal, that is, a radio frequency (RF) signal, to an intermediate frequency (IF) signal according to an IF set by a local oscillator (LO) 125, an Rx attenuator 126 to adjust the IF signal to have an appropriate level of a Received Signal Strength Indication (RSSI), and an analog-to-digital (A/D) converter 127 to sample the adjusted IF signal with IF digital data according to a predetermined sampling clock.

Here, the IF set by the LO 125 may be set by the Rx digital baseband control unit 130.

Also, the Rx digital baseband control unit 130 may collect and store information associated with the measurement signal. The Rx digital baseband control unit 130 may include an Rx switch control unit 131 to control the switches of the switch unit 121 to sequentially input the measurement signal, an Rx automatic gain control (AGC) control unit 132 to input an Rx AGC value in the Rx attenuator 126 and to thereby adaptively adjust the RSSI, and a timing control unit 133 to generate a reference timing signal for the Rx switch control unit 131 and the Rx AGC control unit 132.

Here, the timing control unit 133 may adjust all the timings in order to adaptively adjust an RSSI of a radio wave, received from the N antennas of the antenna unit 110, while sequentially switching the switch unit 121 via the Rx switch control unit 132.

In this instance, IF digital data collected and stored in the Rx digital baseband control unit 130 may include radio channel information that is received via the antenna unit 110, and thus may be used to analyze various types of radio channel environments. Also, the IF digital data may be used to calculate an RSSI value. The RSSI value may be used as a reference value to appropriately adjust a level of the received power through an AGC.

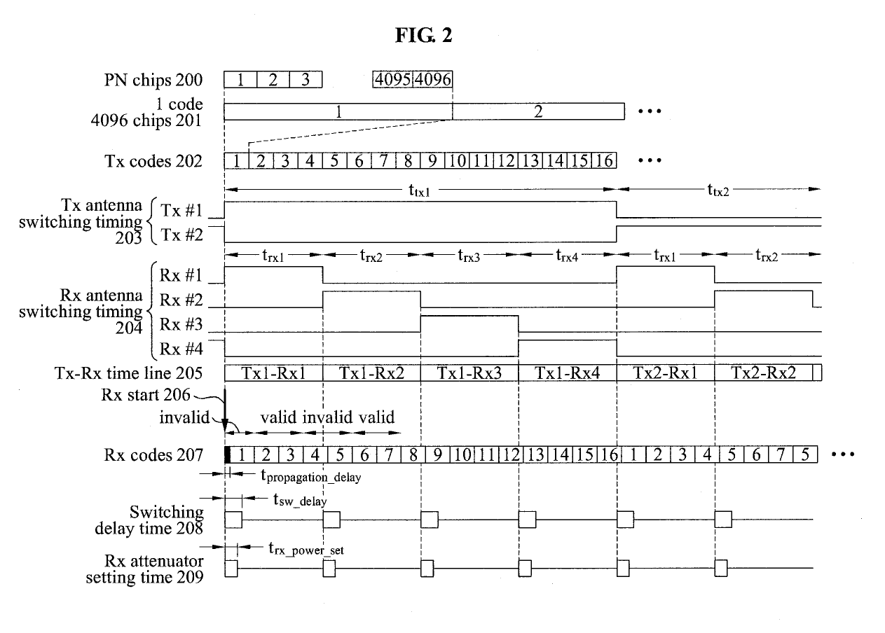

FIG. 2 is a diagram illustrating an example of a reference timing generated by a timing control unit according to an embodiment of the present invention.

Referring to FIG. 2, pseudo-noise (PN) chips 200 may be a probing digital sequence signal that is generally used by a multi-antenna radio channel measurement equipment.

For example, when a length of the PN chips 200 is set to 4096, a basic unit of a measurement signal used to measure a radio channel may be a single code 201. A length of the basic unit may correspond to the length of 4096 chips.

Transmission (Tx) codes 202 transmitted to measure the radio channel may be constructed in a form that the basic code, that is, the code 201 is iteratively transmitted.

In a MIMO multi-antenna radio channel measurement system using M transmit antennas and N receive antennas, let us take an example that a number of transmit antennas is two, that is, M=2, a number of receive antennas is four, that is, N=4, a bandwidth is 100 MHz, and iteration counts for an Rx code is four times.

Here, a switching timing for each of M×N transmit-receive antennas may be like a Tx antenna switching timing 203 and an Rx antenna switching timing 204 as shown in FIG. 2.

Referring to FIG. 2, the receive antennas may be sequentially switched from Rx #1 to Rx #4. A period of time tᵣₓ₁+tᵣₓ₂+tᵣₓ₃+tᵣₓ₄ where the switching timing is performed once with respect to each of the four receiver antennas may be the same as a period of time Tₜₓ₁ where a single transmit antenna, for example, switching timing is performed with respect to Tx #1.

Also, in a sequence of Tx #2, all the receive antenna switching may be alternatively performed as the same as above.

Here, a length of the Rx antenna switching timing 204 may be determined based on an iteration count of the Rx code based on a given parameter. For example, when the iteration count of the Rx code is four, that is, when the Rx code is iterated four times, the length of the Rx antenna switching timing 204 may be the same as four times of the length of the code 201.

When the bandwidth is 100 MHz, a time of the code 201 may be calculated according to the following Equation 1:

Time of 1 code=length of PN chips×(1/bandwidth)=4096×10ns=40.96us. [Equation 1]

Also, the Rx antenna switching timing 204 may be calculated according to the following Equation 2, and the Tx antenna switching timing 203 may be calculated according to the following Equation 3:

Rx antenna switching timing=(tᵣₓ₁)=(tᵣₓ₂)=(tᵣₓ₃)=(tᵣₓ₄)=time of 1 code×(iteration count of Rx code)=40.96us×4=163.84us. [Equation 2]

Tx antenna switching timing=(tₜₓ₁)=(tₜₓ₂)=(tᵣₓ₁+tᵣₓ₂+tᵣₓ₃+tᵣₓ₄)=Rx antenna number×Rx antenna switching timing=4×163.84us=655.36us. [Equation 3]

Accordingly, when the radio channel measurement equipment using the TDM scheme classifies Rx codes 207 for each of M×N transmit-receive antennas according to the Rx antenna switching 204 by referring to the timing diagram of FIG. 2, the Rx codes 207 may be classified like a Tx-Rx time line 205.

Also, data received for (Tx1-Rx1) of the Tx-Rx time line 205 may correspond to data that is transmitted from Tx #1 and is received by Rx #1. After a point in time of an Rx start 206, the Rx codes 206 may be classified into data according to each of (Tx1-Rx1), (Tx1-Rx2), (Tx1-Rx3), (Tx1-Rx4), (Tx2-Rx1), (Tx2-Rx2), (Tx2-Rx3), and (Tx2-Rx4), using the same classification scheme as above.

The Rx codes 207 may be received in such a manner that the Tx codes 202 may pass through radio paths and thereby be propagation delayed by a radio wave delay time t_{propagation}_{_{—}}_{delay} in various types of environments.

In the finally received Rx codes 207, loss of data and transformation may occur due to a delay caused by a switch hardware structure of transmit-receive antennas, that is, due to a switching delay time 208.

Accordingly, the finally received Rx codes 207 may be classified again to data of valid intervals and data of invalid intervals.

As shown in FIG. 2, in the Rx codes 207, the data of the valid intervals may be classified into data 2 and 3 received for (Tx1-Rx1), data 6 and 7 received for (Tx1-Rx2), and the like.

The MIMO multi-antenna radio channel measurement equipment of the TDM scheme may use, as radio channel analysis data, only information classified as valid data through the above process. According to an embodiment of the present invention, it is possible to calculate an RSSI value for controlling the level of received power based on the valid data.

RSSI values using valid data may be classified for each of M×N transmit-receive antennas. The classified RSSI values may be used to adaptively control the Rx power level for each of the M×N transmit-receive antennas.

According to an embodiment of the present invention, an RSSI value for each of M×N transmit-receive antennas may be calculated based on a valid value received for each of (Tx1-Rx1), (Tx1-Rx2), (Tx1-Rx3), (Tx1-Rx4), (Tx2-Rx1), (Tx2-Rx2), (Tx2-Rx3), and (Tx2-Rx4), as shown in the Tx-Rx time line 205 of FIG. 2. The calculated RSSI value may be changed to a new Rx AGC value for setting an optimal level of power for each of the M×N transmit-receive antennas, and then be applied for a period of time tᵣₓ_{_{—}}_{power}_{_{—}}ₛₑₜ in an Rx attenuator setting time 209.

Specifically, the AGC value may be newly calculated based on the RSSI value that is calculated using the Rx codes 207 received for (Tx1-Rx1). A time where the Rx AGC control unit 132 sets the newly calculated AGC value in the Rx attenuator 126 may be performed in a time where a transmission is performed from the same transmit antenna Tx #1 to Rx #1, that is, first time interval of the Rx attenuator setting time 209 within the next (Tx1-Rx1) period. Also, the newly calculated AGC value to control the Rx power for each of the M×N transmit-receive antennas may be applied in a subsequent (M×N)^{th} Rx attenuator setting time.

According to an embodiment of the present invention, an apparatus for adaptively controlling a received power of a multi-antenna radio channel measurement equipment may set an Rx attenuator setting time using the aforementioned scheme to thereby effectively use an invalid time of an RX code, and may immediately apply the AGC control for each of M×N transmit-receive antennas to thereby reflect an optimal Rx power level in valid data. Also, the adaptive control apparatus may control a RSSI value, received for each of receive antennas, to overcome a strength difference caused by a reception path and to thereby be uniformly distributed, and may accurately analyze a multi-path characteristic for each MIMO multi antenna when analyzing radio channel data.

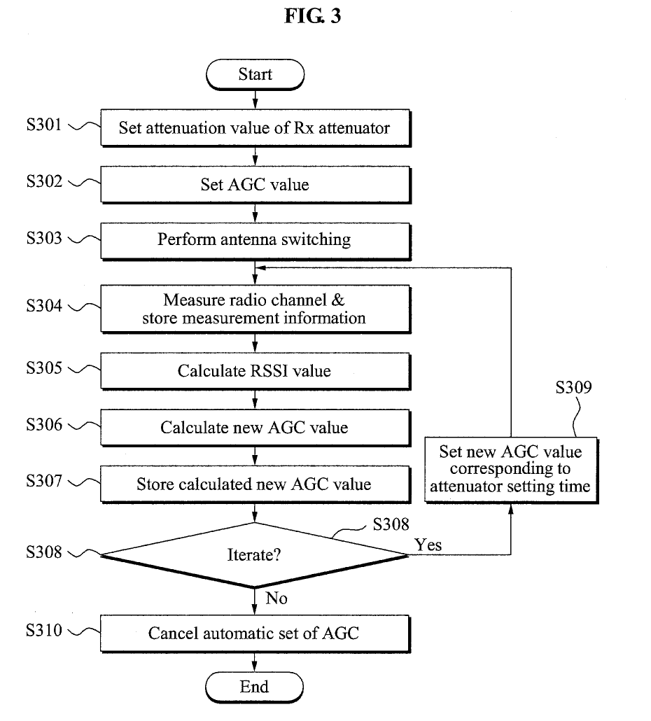

FIG. 3 is a flowchart illustrating a method of adaptively controlling a received power of a multi-antenna radio channel measurement equipment according to an embodiment of the present invention; and

In operation S301, an Rx AGC control unit may set an attenuation value of an Rx attenuator at a maximum value.

Here, the Rx attenuator may maximize the attenuation value to thereby effectively decrease an RSSI, received by a receiver in an initial reception path, which results in preventing the RS SI from being saturated from a start of the reception.

In operation S302, an Rx digital baseband control unit may automatically set an AGC value.

In operation S303, an RX switch control unit may sequentially switch M transmit antennas and N receive antennas according to a predetermined timing in a transmitter with the M transmit antennas and a receiver with the N receive antennas, respectively.

In operation S304, the Rx digital baseband control unit may measure a radio channel for each of M×N transmit-receive antennas to generate measurement information.

Here, the Rx digital baseband control unit may verify whether information measured via the radio channel for each of the M×N transmit-receive antennas may be determined as valid information, and generate, as the measurement information, the information that is determined as the valid information.

Also, the Rx digital baseband control unit may measure the radio channel for each of the M×N transmit-receive antennas according to the timing diagram of FIG. 2. For example, referring to FIG. 2, information classified as data of valid intervals in the Rx codes 207 may be determined as the valid information.

The Rx digital baseband control unit may store the generated measurement information in operation S304.

In operation S305, the Rx AGC control unit may calculate an RSSI value for each of the M×N transmit-receive antennas based on the measurement information.

In operation S306, the Rx AGC control unit may calculate a new AGC value based on the RSSI value and a predetermined threshold value.

Here, the predetermined threshold value reflects a hardware characteristic of an A/D converter. Therefore, when the RSSI value is greater than the predetermined threshold value, the predetermined threshold value may be set to a value that may exclude a probability that a received signal is saturated whereby it is impossible to estimate multiple paths.

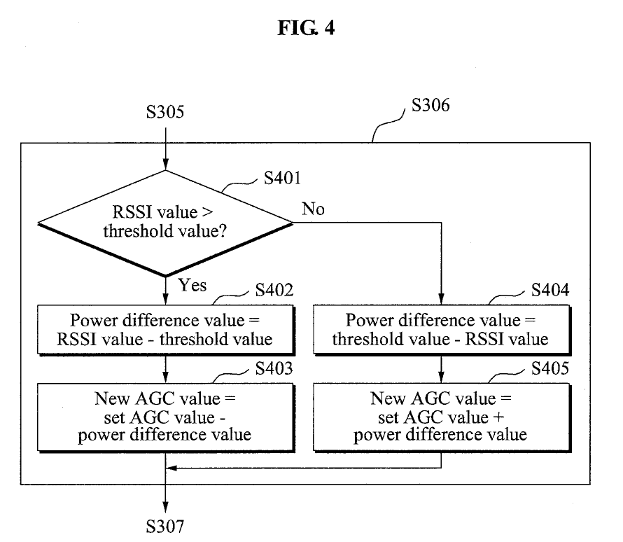

Operation S306 will be further described in detail later with reference to FIG. 4.

In operation S307, the Rx AGC control unit may store the calculated new AGC value. In this instance, for the subsequent RSSI control, the Rx AGC control unit may store the AGC value that is newly calculated for each of the M×N transmit-receive antennas in operation S306.

In operation S308, the Rx digital baseband control unit may determine whether to iterate the measurement of the radio channel.

When it is determine to iterate the measurement, the Rx digital baseband control unit may set the AGC value, calculated in operation S306, corresponding to an attenuator setting time of each of the M×N transmit-receive antennas in operation S309, and then go to operation S304.

Conversely, when it is determined to suspend the measurement, the Rx digital baseband control unit may cancel an automatic set of the AGC.

FIG. 4 is a flowchart illustrating operation S306 of FIG. 3. As shown in FIG. 4, operations S401 through S405 may be included in operation S306 of FIG. 3 and thereby be performed.

In operation S401, the Rx AGC control unit may determine whether the calculated RSSI value is greater than the predetermined threshold value.

When the calculated RSSI value is greater than the predetermined threshold value, the Rx AGC control unit may calculate, as a power difference value, a value that is obtained by subtracting the threshold value from the calculated RSSI value in operation S402.

In operation S403, the Rx AGC control unit may calculate, as a new AGC value, a value that is obtained by subtracting the power difference value from the formerly set AGC value.

Conversely, when the calculated RSSI value is less than or equal to the predetermined threshold value, the Rx AGC control unit may calculate, as a power difference value, a value that is obtained by subtracting the calculated RSSI value from the threshold value in operation S404.

In operation S405, the Rx AGC control unit may calculate, as a new AGC value, a value that is obtained by adding up the power difference value and the formerly set AGC value.

As described above, according to embodiments of the present invention, it is possible to classify, for each of transmit-receive antennas, an RSSI of a radio wave, received by a receiver of a MIMO multi-antenna radio channel measurement system using a TDM scheme, to estimate a corresponding RSSI value, and to adaptively control an attenuation value of the receiver according to a combination of transmit antennas and receive antennas based on the estimated RSSI value. Through this, it is possible to collect optimal reception data, and to control the RSSI, received for each of the receive antennas, to overcome a strength difference caused by a reception path, and to be uniformly distributed. Also, it is possible to set an Rx attenuator setting time and to thereby effectively use an invalid time of received data and to immediately apply a new Rx AGC value for each of M×N transmit-receive antennas.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for adaptively controlling a received power of a multi-antenna radio channel measurement equipment, the apparatus comprising:
a plurality of antennas to receive a measurement signal;
a switch unit comprising a plurality of switches to input the measurement signal;
a switch control unit to control the plurality of switches of the switch unit to sequentially input the measurement signal;
a reception (Rx) attenuator to adjust a Received Signal Strength Indication (RSSI) of the measurement signal;
an Rx AGC control unit to control the Rx attenuator to adaptively adjust the RSSI of the measurement signal;
a timing control unit to generate a reference timing signal for the switch control unit and the Rx AGC control unit; and
a digital baseband control unit to collect and store information associated with the measurement signal.

2. The apparatus of claim 1, wherein the Rx AGC control unit classifies an RSSI of a radio wave, received for each of M×N transmit-receive antennas, to estimate a corresponding RSSI value based on a transmit antenna switching timing and a receive antenna switching timing that are provided from the timing control unit, and adaptively controls the Rx attenuator based on the estimated RSSI value.

3. The apparatus of claim 1, wherein the Rx AGC control unit sets an Rx attenuator setting time to immediately apply a newly set Rx AGC value to a switching delay time of M×N transmit-receive antennas, and the Rx AGC value is newly set for each of M×N transmit-receive antennas.

4. The apparatus of claim 1, wherein the Rx AGC control unit uses, as information to calculate a RSSI value, only valid data that is used as radio channel analysis information by the multi-antenna radio channel measurement equipment.

5. The apparatus of claim 4, wherein the Rx AGC control unit classifies the RSSI value using the valid data for each of M×N transmit-receive antennas, and adaptively controls the Rx attenuator based on the classified RSSI value.

6. The apparatus of claim 5, wherein, when the classified RSSI value is greater than a predetermined threshold value, the Rx AGC control unit calculates, as a power difference value, a value that is obtained by subtracting the threshold value from the classified RSSI value, and calculates, as a new automatic gain control (AGC) value for controlling the Rx attenuator, a value that is obtained by subtracting the power difference value from the formerly set AGC value.

7. The apparatus of claim 5, wherein, when the classified RSSI value is less than or equal to a predetermined threshold value, the Rx AGC control unit calculates, as a power difference value, a value that is obtained by subtracting the classified RSSI value from the threshold value, and calculates, as a new AGC value for controlling the Rx attenuator, a value that is obtained by adding up the power difference value and the formerly set AGC value.

8. A method of adaptively controlling a received power of a multi-antenna radio channel measurement equipment, the method comprising:
setting a value of an Rx attenuator at a maximum value;
automatically setting an AGC value;
sequentially switching M transmit antennas and N receive antennas according to a predetermined timing;
measuring a radio channel for each of M×N transmit-receive antennas to generate measurement information;
calculating an RSSI value for each of the M×N transmit-receive antennas, based on the measurement information;
calculating a new AGC value based on the RSSI value and a predetermined threshold value; and
storing the AGC value.

9. The method of claim 8, wherein the measuring and the generating comprises:
measuring the radio channel for each of the M×N transmit-receive antennas;
verifying whether information measured via the radio channel for each of the M×N transmit-receive antennas is determined as valid information in the multi-antenna radio channel measurement equipment; and
generating and storing, as the measurement information, the information that is determined as the valid information.

10. The method of claim 8, wherein the calculating of the RSSI value classifies an RSSI of a radio wave, received for each of M×N transmit-receive antennas, to estimate a corresponding RSSI value based on a transmit antenna switching timing and a receive antenna switching timing.

11. The method of claim 8, wherein the calculating of the AGC value comprises:
determining whether the calculated RSSI value is greater than the predetermined threshold value;
calculating an AGC value of valid information where the calculated RSSI value is greater than the predetermined threshold value;
calculating an AGC value of valid information where the calculated RSSI value is less than or equal to the predetermined threshold value.

12. The method of claim 11, wherein the calculating of the AGC value of the valid information where the calculated RSSI value is greater than the predetermined threshold value comprises:
calculating, as a power difference value, a value that is obtained by subtracting the threshold value from the calculated RSSI value; and
calculating, as a new AGC value, a value that is obtained by subtracting the power difference value from the formerly set AGC value.

13. The method of claim 11, wherein the calculating of the AGC value of the valid information where the calculated RSSI value is less than or equal to the predetermined threshold value comprises:
calculating, as a power difference value, a value that is obtained by subtracting the calculated RS SI value from the threshold value; and
calculating, as a new AGC value, a value that is obtained by adding up the power difference value and the formerly set AGC value.

14. The method of claim 8, further comprising:
determining whether to iterate the measurement of the radio channel;
setting the calculated AGC value corresponding to an attenuator setting time of each of the M×N transmit-receive antennas, and measuring the radio channel for each of the M×N transmit-receive antennas to generate the measurement information, when it is determined to iterate the measurement; and
canceling an automatic set of the AGC, when it is determined to suspend the measurement.
